(19) United States
(12) Patent Application Publication
(10) Pub. No.: US 2025/0094099 A1
(43) Pub. Date: Mar. 20, 2025

(54) CONTROL DEVICE, NON-TRANSITORY COMPUTER-READABLE RECORDING MEDIUM STORING COMPUTER-READABLE INSTRUCTIONS FOR CONTROL DEVICE, AND METHOD FOR CONTROLLING CONTROL DEVICE

(71) Applicant: BROTHER KOGYO KABUSHIKI KAISHA, Nagoya (JP)

(72) Inventors: Longlong RUAN, Nagoya (JP); Tetsuya OKUNO, Nagoya (JP)

(21) Appl. No.: 18/826,392

(22) Filed: Sep. 6, 2024

(30) Foreign Application Priority Data
Sep. 15, 2023 (JP) 2023-150031

(51) Int. Cl. G06F 3/12

(52) U.S. Cl. CPC G06F 3/1222; G06F 3/1238; G06F 3/1288

(57) ABSTRACT

A control device comprising may, in a case where a function executing device is in a non-accepting state in which the function executing device is not capable of accepting an authentication operation, display notification information regarding the non-accepting state on a display of a terminal device before displaying an instruction screen for prompting a user to execute the authentication operation on the display.

### REFERENCE TO RELATED APPLICATIONS

This application claims priority to Japanese Patent Application No. 2023-150031 filed on Sep. 15, 2023. The entire content of the priority application is incorporated herein by reference.

### BACKGROUND ART

A print system including a mobile terminal device, a printer, and a server is known. When the printer accepts physical authentication from a user after the printer has received a start notification for physical authentication, the printer sends information indicating that the printer has accepted the physical authentication to the mobile terminal device.

### SUMMARY

In the above system, no consideration had been given to a possibility that the printer may fall into a state of being unable to accept the physical authentication. The present teachings provide an art configured to improve user convenience.

The disclosure herein discloses a non-transitory computer-readable recording medium storing computer-readable instructions for a control device. The computer-readable instructions, when executed by the processor, may cause the control device to: in a case where a function executing device is in a non-accepting state in which the function executing device is not capable of accepting an authentication operation, display notification information regarding to the non-accepting state on a display of a terminal device before displaying an instruction screen for prompting a user to execute the authentication operation on the display.

According to the above configuration, in a case where the function executing device is in the non-accepting state, the controller causes the display unit to display the notification information before the display unit of the terminal device is caused to display the instruction screen. Due to this, the user can acknowledge that the function executing device is in the non-accepting state before the user performs the authentication operation on the function executing device. Accordingly, user convenience can be improved.

A non-transitory computer-readable recording medium storing computer-readable instructions for a control device as described above, a control device realized by the above-described non-transitory computer-readable recording medium, and a method of controlling the control device are also novel and useful. Further, a communication system including a control device, a function executing device, and a terminal device is also novel and useful.

### BRIEF DESCRIPTION OF DRAWINGS

FIG. 1 illustrates a configuration of a communication system.

FIG. 2 illustrates examples of respective tables.

FIG. 3 illustrates a flow chart of an app process executed by a terminal device.

FIG. 4 illustrates a first screen display process executed by the terminal device.

FIG. 5 illustrates a flowchart of a second screen display process executed by the terminal device.

FIG. 6 illustrates a flowchart of a third screen display process executed by the terminal device.

FIG. 7 illustrates an example of screens displayed on the terminal device in Case A in which the printer is unregistered in the terminal device and the user has not subscribed to a service.

FIG. 8 illustrates an example of screens displayed on the terminal device in Case B in which the printer is registered in the terminal device and the user has not subscribed to the service.

FIG. 9 illustrates an example of screens displayed on the terminal device in Case C in which the printer is registered in the terminal device and the user has not subscribed to the service.

FIG. 10 illustrates an example of screens displayed on the terminal device in Case D in which the printer is registered in the terminal device and the user has subscribed to a charge service.

FIG. 11 illustrates a list of second messages included in notification information.

FIG. 12 illustrates a flowchart of a printer process executed by a printer in a first modification.

### DESCRIPTION

### First Embodiment

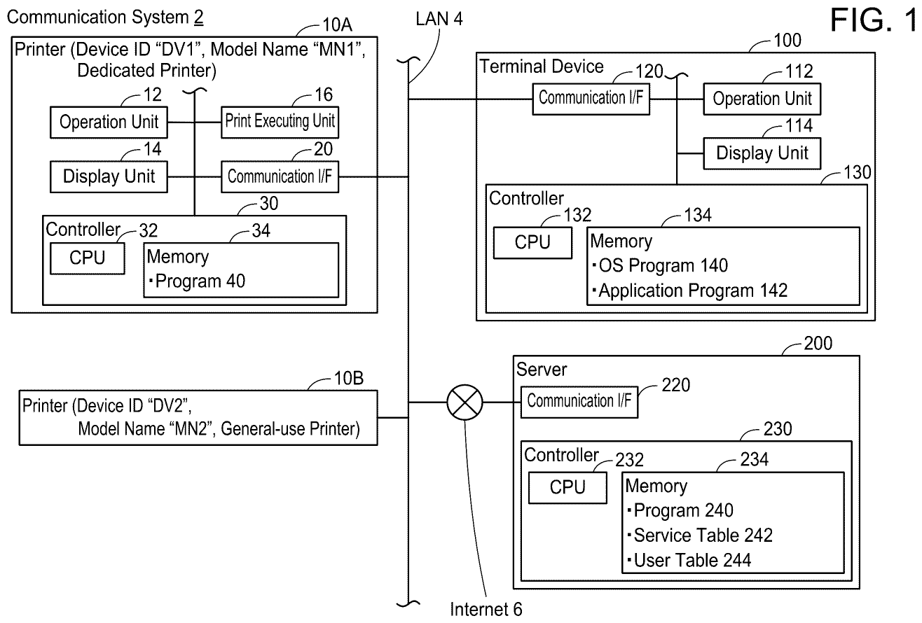

### (Configuration of Communication System 2; FIG. 1)

As shown in FIG. 1, a communication system 2 comprises a plurality of printers 10A, 10B, a terminal device 100, and a server 200. The printers 10A, 10B and the terminal device 100 are connected to Local Area Network (LAN) 4. The printers 10A, 10B, and the terminal device 100 are configured to communicate with each other via the LAN 4. The printers 10A, 10B, the terminal device 100, and the server 200 are connected to the Internet 6. The printers 10A, 10B, the terminal device 100, and the server 200 are configured to communicate with each other via the Internet 6.

### (Configuration of Server 200)

The server 200 is arranged on the Internet 6 by a vendor of the printers 10A, 10B (hereafter, simply termed “vendor”). The server 200 may be a physical server, a virtual server or a virtual machine on cloud, for example. The server 200 may comprise a single server or multiple servers as a unit. The server 200 may be a server on an intranet or a cloud server on the Internet 6. In a modification, the server 200 may be installed on the Internet 6 by a business entity different from the vendor. In another modification, the vendor may not prepare hardware of the server 200 by themselves, but may implement an environment provided by an external cloud computing service. In this case, the vendor may prepare a program (software) for the server 200, and have the program introduced in the above environment to realize the server 200. In the present embodiment, as an example, a configuration in which the server 200 is a physical server will be described.

The server 200 provides a plurality of types of services related to printing. The plurality of types of services includes a charge service, a remote print service, and a subscription service. The charge service is a service for which a fee is charged. The charge service is a service which allows to print a number of sheets according to a paid fee by a user paying the fee in advance. Specifically, in the charge service, the fee that was paid in advance (billed price) by the user is subtracted each time a print function is executed. The remote print service is a service for which a fee is not charged. The remote print service allows to send a print instruction to a printer via the server 200 from outside the home. The user can use the remote print service without fees as long as the user signs up to the service. The subscription service is a service for which a fee is charged. The subscription service charges a fixed fee if the number of sheets printed within a predetermined period (e.g., one month) is less than or equal to a contracted number of printed sheets (e.g., 1000 sheets), and charges a price obtained by totaling the fixed fee and a fee according to the printed number of sheets exceeding the contracted number of printed sheets if the number of printed sheets within the predetermined period exceeds the contracted number of printed sheets. The charge service and the subscription service also include an automatic ordering service of automatically ordering a new cartridge in a case where a remaining amount of ink in a cartridge mounted in the printer becomes a predetermined remaining amount or less.

The server 200 comprises a communication interface 220 and a controller 230. Hereafter, an interface will be referred to as “I/F”. The communication I/F 220 is connected to the Internet 6. The controller 230 comprises a CPU 232 and a memory 234. The memory 234 comprises a primary storage and an auxiliary storage. Although this is merely an example, the primary storage includes a RAM and cache. Although this is merely an example, the auxiliary storage may include a ROM, flash memory, a solid state drive (SSD), hard disk drive (HDD), or a combination thereof. The auxiliary storage of the memory 234 has a program 240, a service table 242, and a user table 244 stored therein. The CPU 232 realizes various types of process in accordance with a program loaded from the auxiliary storage to the primary storage.

### (Configurations of Printers 10A, 10B)

The printer 10A is a peripheral device configured to execute a print function. In a modification, the printer 10A may be a multi-function peripheral configured to execute a scan function, a facsimile function, and a copy function in addition to the print function. The printer 10A has a device ID “DV1” and a model name “MN1”. The device ID is a name given by an administrator of the printer. The model name is a name indicative of a model of a printer. In the present embodiment, there are a plurality of types of printers including a dedicated printer and a general-use printer. The dedicated printer is capable of receiving provision of the charge service and the remote print service but is uncapable of receiving provision of the subscription service. In the dedicated printer, the execution of the print function is allowed on condition that the device ID of the printer is registered in the server 200 as a printer which receives the provision of the charge service. Here, in the dedicated printer, as long as the device ID of the printer is registered in the server 200 as a printer which receives the provision of the charge service, the execution of the print function is allowed even when the device ID is not registered in the server 200 as the printer which receives the provision of the remote print service. The general-use printer is capable of receiving provision of the remote print service and the subscription service but is incapable of receiving the provision of the charge service. In the general-use printer, even when the device ID of the printer is not registered in the server 200 as a printer which receives provision of the service, the execution of the print function is allowed. The printer 10A is a dedicated printer. The printer 10A comprises an operation unit 12, a display unit 14, a print executing unit 16, and a communication I/F 20.

The operation unit 12 is an I/F which enables the user to input various types of information to the printer 10A. The operation unit 12 comprises hardware key(s), software key(s) (object(s)) or a combination thereof. For example, the operation unit 12 comprises a touch screen, button(s), or a combination thereof. The display unit 14 is a display or panel for displaying the various information. The panel may or may not be a touch panel. Also, the panel is for example a liquid crystal display panel, an organic EL panel. The print executing unit 16 comprises a print engine such as ink jet scheme, electrophotographic scheme, or thermal scheme. The print engine of ink jet scheme comprises a print head which sprays ink droplets. The print engine of electrophotographic scheme comprises a photoreceptor and an exposure device that emits light to expose the photoreceptor. The print engine of thermal scheme comprises a print head that generates heat with a heater. The communication I/F 20 is connected to the LAN 4. The communication I/F 20 may be a wired I/F or may be a wireless I/F.

A controller 30 comprises a CPU 32 and a memory 34. The memory 34 comprises a primary storage and an auxiliary storage. The auxiliary storage of the memory 34 has a program 40 stored therein. The CPU 32 realizes various process in accordance with a program loaded from the auxiliary storage to the primary storage.

The printer 10A operates in one of an accepting state in which the printer 10A is capable of accepting physical authentication and a non-accepting state in which the printer 10A is incapable of accepting the physical authentication. Here, the printer 10A is configured to manage in which state the printer 10A is in, the accepting state or the non-accepting state by using a flag (not shown) stored in the memory 34. The physical authentication is an authentication operation for authenticating the user, and is a physical operation on the printer 10A. The physical operation includes an operation on the hardware key(s), operation on the software key(s) or a combination thereof. The printer 10A authenticates in response to such operation being performed. The authentication can be regarded as authentication for assuring that the user is nearby the printer 10A. In the present embodiment, the physical authentication is an operation required for the user to subscribe to a service for the first time. The printer 10A operates in the non-accepting state in a case where the printer 10A is offline, the printer 10A is in execution of (is now executing) the print function, the user is operating the operation unit 12 of the printer 10A, or communication is inexecutable between the printer 10A and the server 200. Here, the state in which the printer 10A is offline means a state in which the terminal device 100 cannot detect the printer 10A by using communication. The state in which communication is inexecutable between the printer 10A and the server 200 means a state in which the server 200 is down, there is failure in the Internet 6. The printer 10A operates in the accepting state in a case where the printer 10A is online, the printer 10A is not in execution of the print function, the user is not operating the operation unit 12 of the printer 10A, and communication is executable between the printer 10A and the server 200.

The printer 10B has the same configuration as that of the printer 10A except that the printer 10B has a device ID “DV2” and a model name “MN2” and is a general-use printer. Since the printer 10B is a general-use printer, the execution of a print function of the printer 10B is permitted upon when the printer 10B has been purchased.

### (Configuration of Terminal Device 100)

The terminal device 100 is a terminal device such as a mobile phone (e.g., smartphone), PDA, a tablet PC, a desktop PC, a laptop PC. The terminal device 100 comprises an operation unit 112, a display unit 114, a communication I/F 120, and a controller 130.

The operation unit 112 is an I/F configured to enable a user to input various information to the terminal device 100, and comprises a touchscreen, button(s), or a combination thereof, for example. The display unit 114 is a display or a panel for displaying the various information. The panel may or may not be a touch panel. Also, the panel is for example a liquid crystal display panel, an organic EL panel. The communication I/F 120 is connected to the LAN 4.

The controller 130 comprises a CPU 132 and a memory 134. The memory 134 comprises a primary storage and an auxiliary storage. The auxiliary storage of the memory 134 has an OS program 140 and an application program 142 stored therein. Hereafter, the OS program 140 and the application program 142 will be referred to as “OS 140” and “app 142”. The OS 140 controls basic operations of the terminal device 100. The app 142 causes the printer 10A for example to execute a print function. The CPU 132 realizes various types of process in accordance with a program loaded from the auxiliary storage to the primary storage.

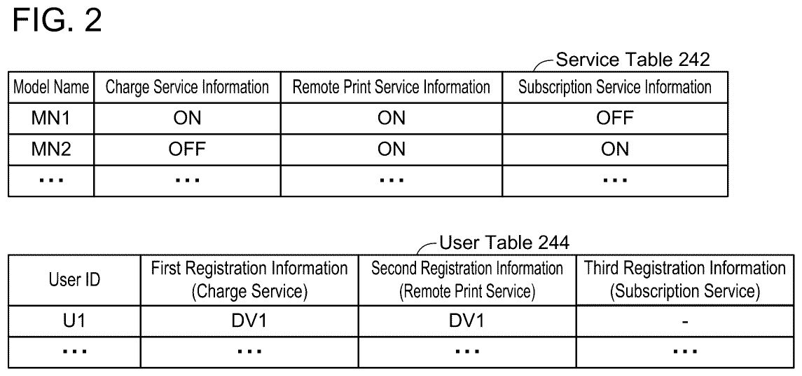

### (Configurations of Tables 242, 244; FIG. 2)

With reference to FIG. 2, a service table 242 and a user table 244 in the memory 234 of the server 200 will be described.

The service table 242 is for managing service information corresponding to each of the plurality of types of services. In the service table 242, a model name, charge service information, remote print service information, and subscription service information are stored in association with each other. Each of the charge service information, the remote print service information, and the subscription information indicates one value of “ON” indicating that the service is supported and “OFF” indicating that the service is not supported. The respective information in the service table 242 is set by an administrator of the server 200. In the present embodiment, in the service information associated with a specific model (e.g., “MN1”), the charge service information and the subscription service information both are never set to “ON”.

The user table 244 is for managing registration information corresponding to each of the plurality of types of services. In the user table 244, a user ID and first registration information corresponding to the charge service, second registration information corresponding to the remote print service, and third registration information corresponding to the subscription service are stored in association with each other. In the first registration information, a device ID of a printer which receives provision of the charge service is stored. In the second registration information, a device ID of a printer which receives provision of the remote print service is stored. In the third registration information, a device ID of a printer which receives provision of the subscription service is stored.

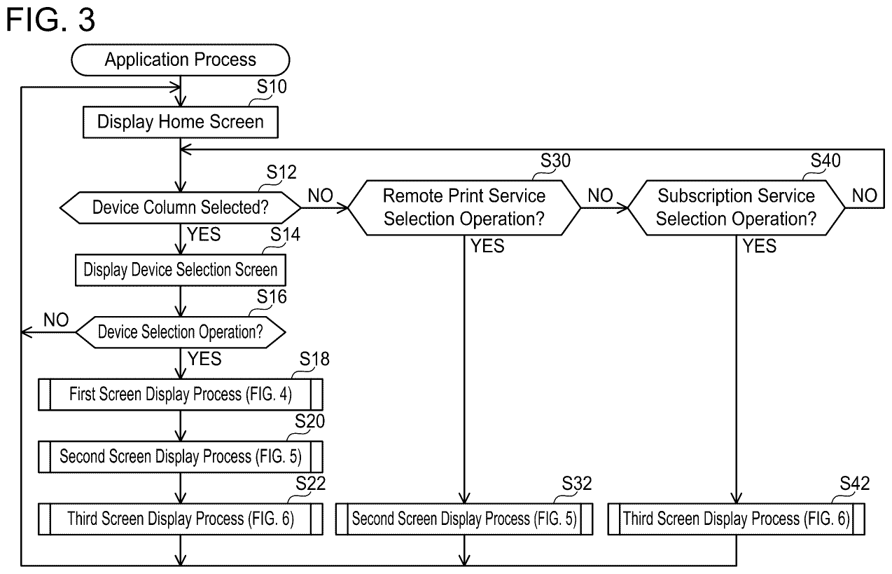

### (Application Process; FIGS. 3 to 10)

With reference to FIGS. 3 to 10, an application process executed by the app 142 of the terminal device 100 will be described. In a case where the app 142 accepts an operation for activating the app 142 (hereafter, “app activating operation”), the app 142 starts process of FIG. 3. Here, the app 142 accesses, via the OS 136, respective hardware such as the display unit 114, the memory 134, the communication I/F 120 and thus executes respective process. Hereafter, the app 142's execution of process via the OS 140 will be described with some of the details omitted. Communication between the respective devices is executed via a communication I/F (e.g., 20, 120, 220). Accordingly, “via a communication I/F” will be omitted when communication is described.

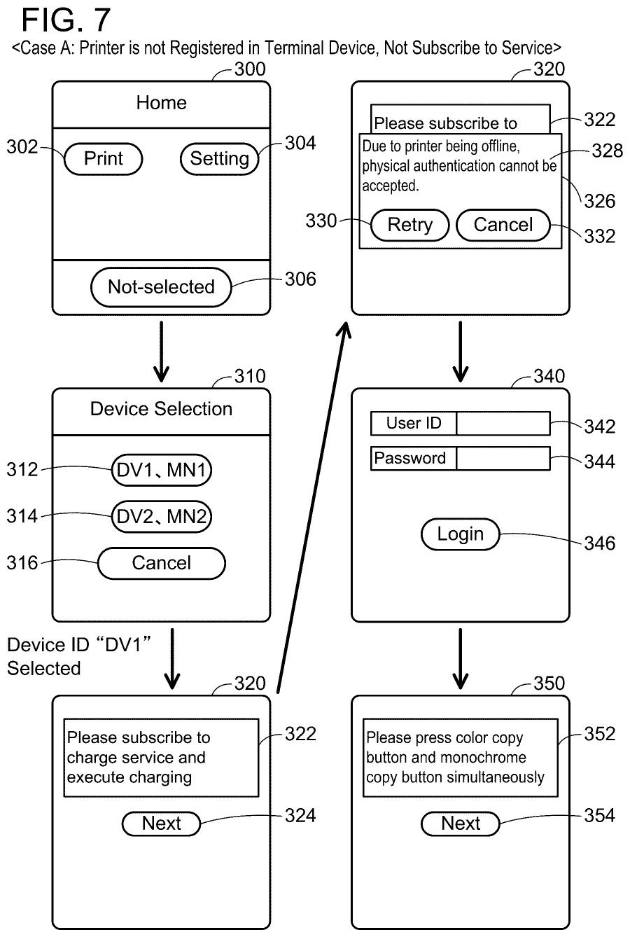

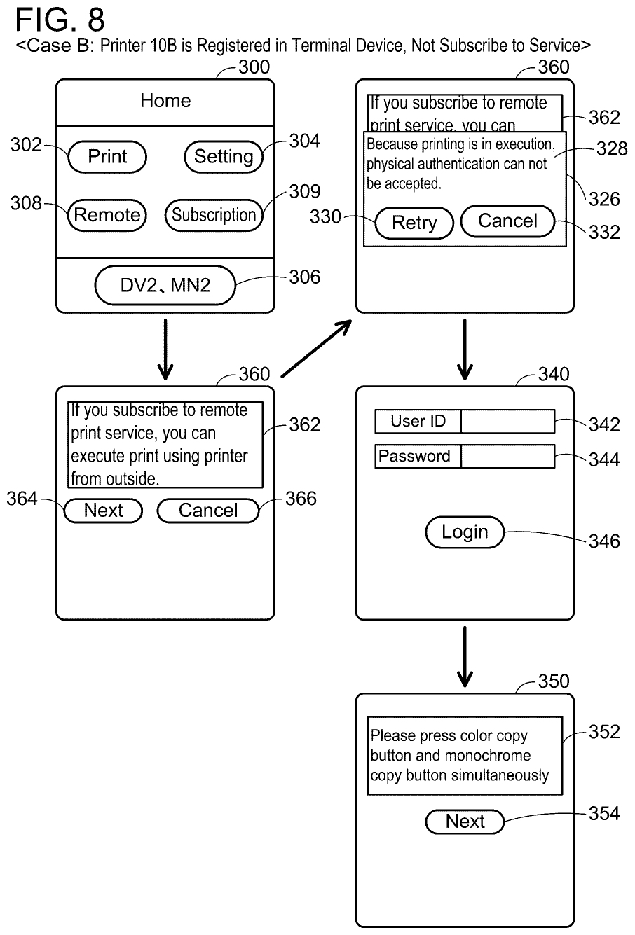

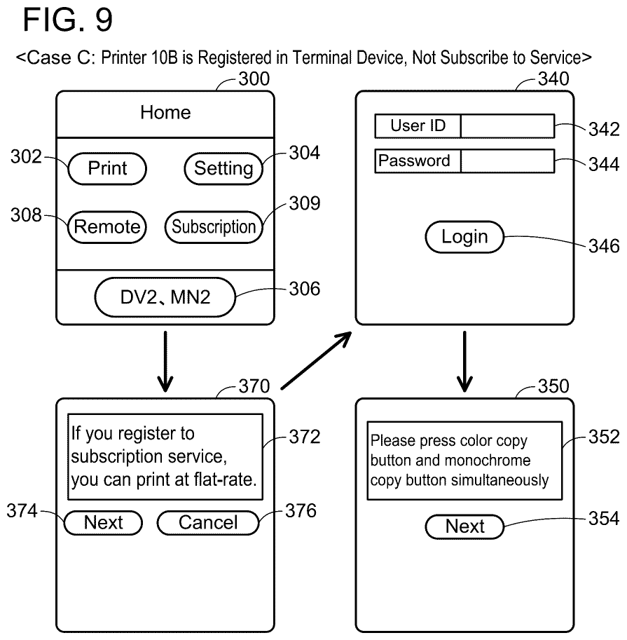

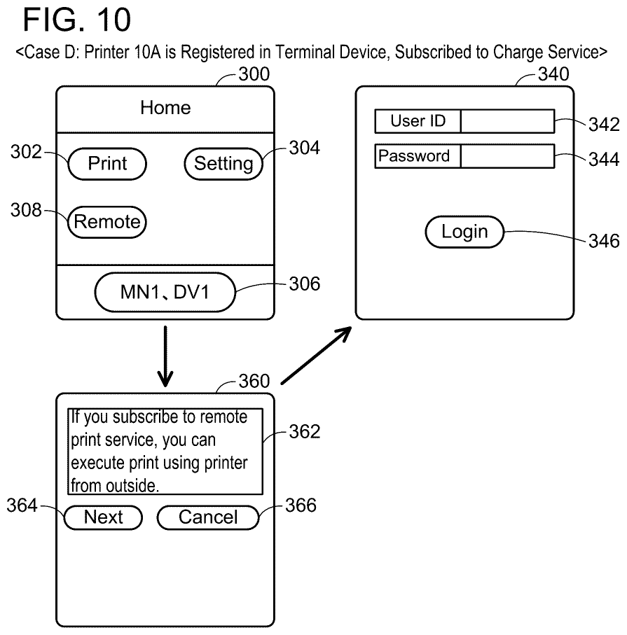

In S10, the app 142 causes the display unit 114 to display a home screen 300 (see FIGS. 7 to 10). Information displayed on the home screen 300 differs according to whether a printer is registered in the terminal device 100 or not. Here, “printer is registered in the terminal device 100” may be said as the printer being registered in the app 142. Also, the information displayed on the home screen 300 differs according to a type of a printer registered in the terminal device 100. As shown in FIG. 7, the home screen 300 in a case where a printer is not registered in the terminal device 100 includes a Print button 302, a Setting button 304, and a device object 306 including a character string “Not Selected”. The device object 306 indicates information related to printer(s) registered in the terminal device 100 as a printer caused to execute a print function via the app 142. The device object 306 serves as a button for searching for printer(s) registered in the terminal device 100. Also, as shown in FIGS. 8 and 9, the home screen 300 in a case where the printer 10B which is a general-use printer is registered in the terminal device 100 includes the Print button 302, the Setting button 304, a Remote button 308, a Subscription button 309, and the device object 306. In the device object 306 in this case, the device ID “DV2” and the model name “MN2” of the registered printer 10B are displayed. The Remote button 308 is for subscribing to the remote print service. The Subscription button 309 is for subscribing to the subscription service. Further, as shown in FIG. 10, the home screen 300 in a case where the printer 10A which is a dedicated printer is registered in the terminal device 100 includes the Print button 302, the Setting button 304, the Remote button 308, and the device object 306. In the device object 306 in this case, the device ID “DV1” and the model name “MN1” of the registered printer 10A are displayed.

In S12 of FIG. 3, the app 142 monitors for the device object 306 (see FIG. 7) on the home screen 300 being operated. The app 142 determines YES to S12 in a case where the app 142 accepts the operation on the device object 306, and proceeds to S14.

In S14, the app 142 executes a search process for searching for printer(s) belonging to the LAN 4, and causes the display unit 114 to display a device selection screen 310 (see FIG. 7). In the search process, the app 142 sends to the LAN 4 a search signal for searching for printer(s) belonging to the LAN 4. In response to the search signal being sent to the LAN 4, the app 142 receives response signal(s) each including the device ID and the model name from the printer(s) belonging to the LAN 4 (in the present embodiment, the two printers 10A, 10B). The app 142 causes the display unit 114 to display the device selection screen 310 by using the received response signals. As shown in FIG. 7, the device selection screen 310 includes device buttons 312, 314 corresponding to the received response signals and a Cancel button 316. The device buttons 312, 314 are for selecting printer(s) to be registered in the terminal device 100. The device buttons 312, 314 respectively correspond to the printers 10A, 10B.

In S16 of FIG. 3, the app 142 determines whether an operation for selecting printer(s) to be registered in the terminal device 100 (hereafter, “device selection operation”) has been performed or not. Specifically, the app 142 determines whether the device buttons 312, 314 (see FIG. 7) on the device selection screen 310 have been operated or not. In a case where the app 142 accepts the operation for selecting the device buttons 312, 314, the app 142 determines that the device selection operation has been performed (YES to S16) and proceeds to S18. Contrary to this, in a case where the app 142 accepts an operation on the Cancel button 316 (see FIG. 7) on the device selection screen 310, the app 142 determines that the device selection operation has not been performed (NO to S16), and returns to S10.

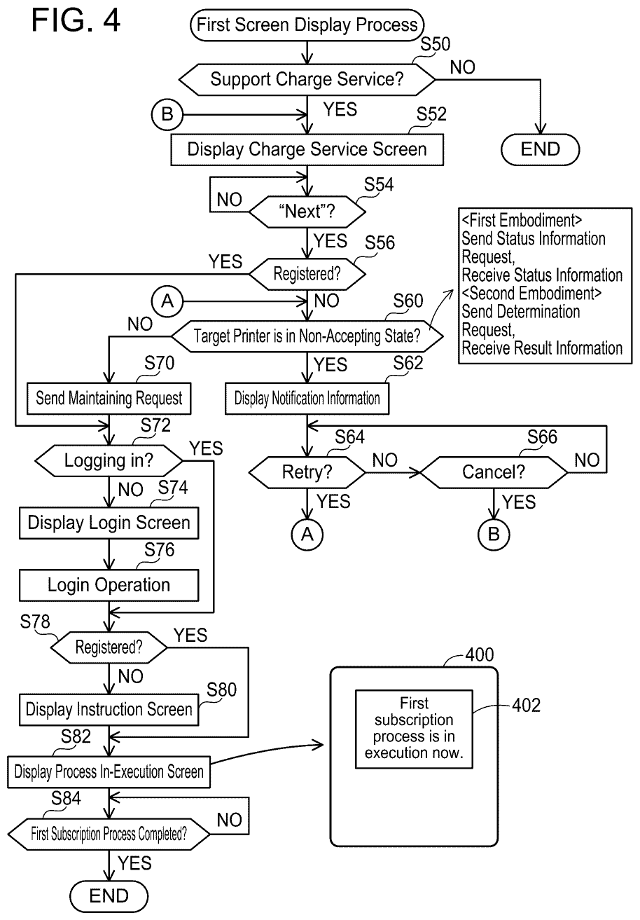

In S18, the app 142 executes a first screen display process (see FIG. 4). The first screen display process is for causing the display unit 114 to display a screen for subscribing to the charge service. When S18 ends, the app 142 proceeds to S20.

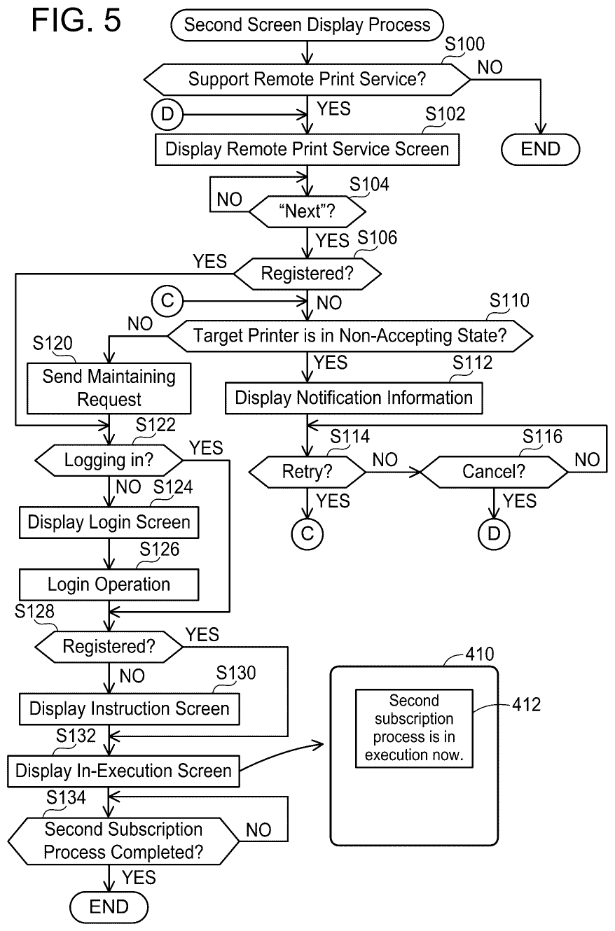

In S20, the app 142 executes a second screen display process (see FIG. 5). The second screen display process is for causing the display unit 114 to display a screen for subscribing to the remote print service. When S20 ends, the app 142 proceeds to S22.

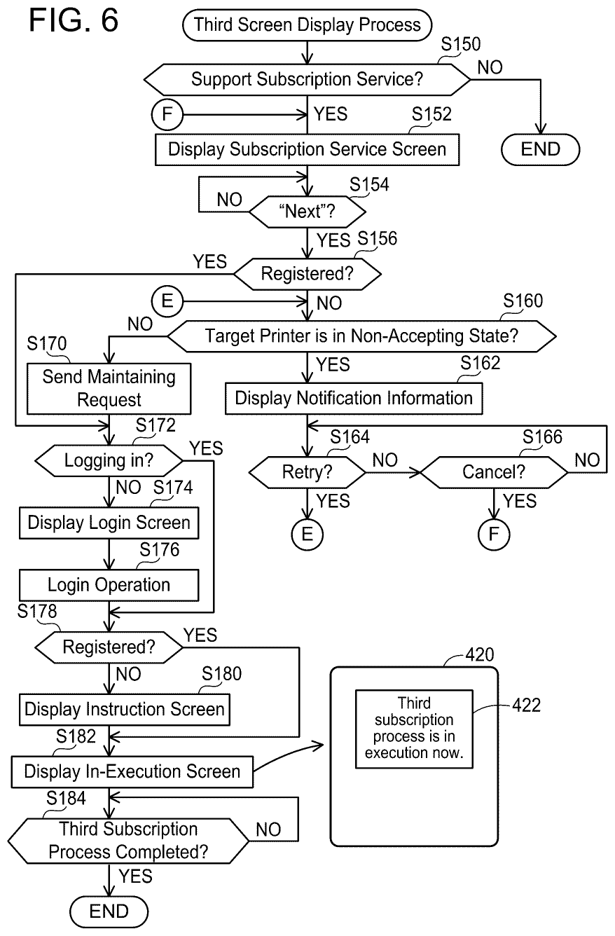

In S22, the app 142 executes a third screen display process (see FIG. 6). The third screen display process is for causing the display unit 114 to display a screen for subscribing to the subscription service. When S22 ends, the app 142 returns to S10. Here, in the case where S22 ends, the app 142 stores the device ID and the model name of the printer selected in S16 in the memory 134. Due to this, registration of the printer to the terminal device 100 is completed.

Further, in S30, the app 142 monitors for an operation for subscribing to the remote print service (hereafter, “remote print service selection operation”) being performed, while performing the monitoring of S12 at the same time. Specifically, the app 142 monitors for the Remote button 308 (see FIG. 8) on the home screen 300 being operated. In a case where the app 142 accepts the operation on the Remote button 308, the app 142 determines that the remote print service selection operation has been performed (YES to S30), and returns to S32.

In S32, the app 142 executes the second screen display process (see FIG. 5). When S32 ends, the app 142 returns to S10.

Also, in S40, simultaneously with the monitoring of S12 and S30, the app 142 monitors for an operation for subscribing to the subscription service (hereafter, “subscription service selection operation”) being performed. Specifically, the app 142 monitors for the Subscription button 309 (see FIG. 8) on the home screen 300 being operated. In a case where the app 142 accepts the operation on the Subscription button 309, the app 142 determines that the remote print service selection operation has been performed (YES to S40), and proceeds to S42.

In S42, the app 142 executes the third screen display process (see FIG. 6). When S42 ends, the app 142 returns to S10. Although this is not shown, the app 142 executes a process for causing the registered printer to execute the print function when the app 142 accepts the operation on the Print button 302 (see FIG. 8) on the home screen 300 in a state where the printer is registered in the terminal device 100. Further, when the app 142 accepts operation on the Setting button 304 (see FIG. 8) on the home screen 300, the app 142 causes the display unit 114 to display a screen for changing the setting of the registered printer.

### (First Screen Display Process; FIGS. 4, 7, and 8)

With reference to FIGS. 4, 7, and 8, the first screen display process executed in S18 of FIG. 3 will be described.

In S50, the app 142 determines whether the printer selected by a user (hereafter, “target printer”) supports the charge service or not. The app 142 sends a support information request including the model name of the target printer (hereafter, “target model name”) to the server 200. The support information request is a signal for requesting the server 200 to send support information. The support information includes service information corresponding to each of the plurality of types of services. When the server 200 receives the support information request from the terminal device 100, the server 200 specifies the service information of each service by using the service table 242 in the memory 234 and the target model name in the request. The server 200 sends the support information including the service information corresponding to each service to the terminal device 100. When the app 142 receives the support information from the server 200, the app 142 determines whether the charge service information in the received support information is “ON” or not. In a case where the charge service information is “ON” (YES to S50), the app 142 proceeds to S52, and in a case where the charge service information is “OFF” (NO to S50), the app 142 ends process of FIG. 4.

In S52, the app 142 causes the display unit 114 to display a charge service screen 320. As shown in FIG. 7, the charge service screen 320 includes a first service message 322 and a Next button 324. The first service message 322 includes information that prompts the user to subscribe to the charge service and pay a fee. Although this is an example, the first service message 322 is “Please subscribe to charge service and execute charging”.

In S54 of FIG. 4, the app 142 monitors for the Next button 324 (see FIG. 7) on the charge service screen 320 being operated. In a case where the app 142 accepts the operation on the Next button 324, the app 142 determines YES to S54 and proceeds to S56.

In S56, the app 142 determines whether the target printer is already registered in the server 200 as a printer for receiving provision of service. The app 142 sends an inquiry signal including the target model name to the server 200. The inquiry signal is for inquiring of whether the target model name is registered in the user table 244 of the server 200 or not. When the server 200 receives the inquiry signal from the terminal device 100, the server 200 determines whether the target model name is registered in the user table 244 of the server 200. In a case where the target model name is registered in the user table 244, the server 200 sends registered information indicating that the target model name is already registered in the terminal device 100, and in a case where the target model name is unregistered (not registered) in the user table 244, the server 200 sends unregistered information indicating that the target model name is unregistered (i.e., not registered) to the terminal device 100. In a case where the app 142 receives the registered information from the server 200, the app 142 determines YES to S56 and proceeds to S72, and in a case where the app 142 receives the unregistered information from the server 200, the app 142 determines NO to S56 and proceeds to S60.

In S60, the app 142 determines whether the target printer is in the non-accepting state or not. The app 142 sends a status information request to the target printer. The status information request is a signal for requesting for status information indicating a status of the target printer to be sent. The status information of the present embodiment includes print-related information indicating whether the target printer is in execution of the print function, operation-related information indicating whether the user is now operating the operation unit of the target printer or not, and communication-related information indicating whether communication is executable between the target printer and the server 200. In a case where the target printer receives the status information request from the terminal device 100, the target printer specifies whether the print function is in execution or not, whether the user is now operating the operation unit of the target printer, and whether communication is executable between the target printer and the server 200. Here, the target printer sends a well-being confirmation signal to the server 200 to thus determine whether communication is executable between the target printer and the server 200. In a case where the target printer receives a response signal to the well-being confirmation signal from the server 200, the target printer determines that communication is executable between the target printer and the server 200, and in a case where the target printer does not receive the response signal from the server 200, the target printer determines that communication is inexecutable between the target printer and the server 200. Then the target printer sends the status information including the print-related information, the operation-related information, and the communication-related information to the terminal device 100. In a case where the print-related information indicates that the target printer is in execution of the print function, in a case where the operation-related information indicates that the user is now operating the operation unit of the target printer, or in a case where the communication-related information indicates that communication is inexecutable between the target printer and the server 200, the app 142 determines that the target printer is in the non-accepting state (YES to S60) and proceeds to S62. Contrary to this, in a case where the print-related information indicates that the target printer is not in execution of the print function, in a case where the operation-related information indicates that now the user is not operating the operation unit of the target printer, and in a case where the communication-related information indicates that communication is executable between the target printer and the server 200, the app 142 determines that the target printer is in the accepting state (NO to S60) and proceeds to S70. Also, in a case where the app 142 does not receive the status information from the target printer, the app 142 determines that the target printer is in the non-accepting state (YES to S60) and proceeds to S62. The case where the app 142 does not receive the status information from the target printer is a case where the target printer is offline.

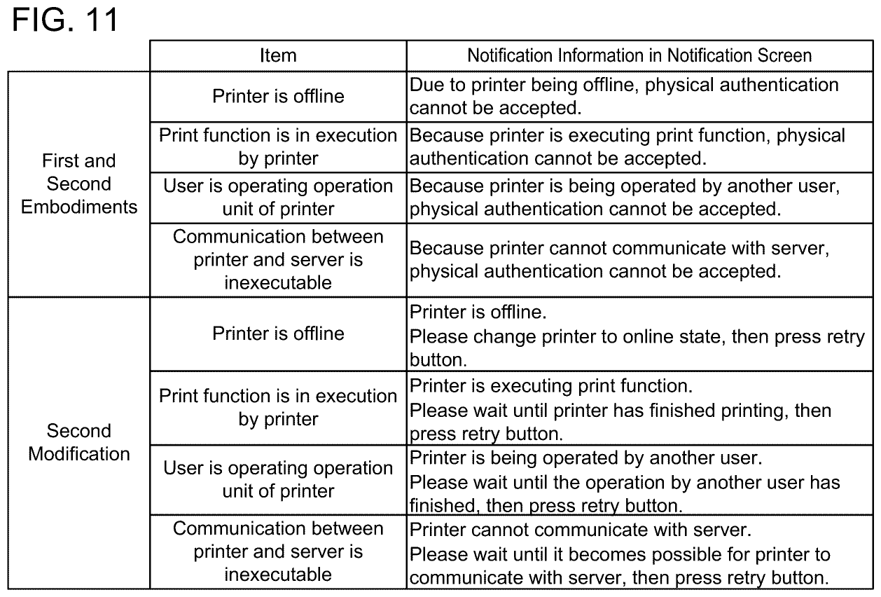

In S62, the app 142 displays a notification screen 326 (see FIG. 7) on the charge service screen 320. As shown in FIG. 7, the notification screen 326 includes notification information 328 indicating that the target printer is in the non-accepting state, a Retry button 330, and a Cancel button 332. The notification information 328 includes information indicating a cause why the target printer is in the non-accepting state. As shown in FIG. 11, although this is merely an example, in a case where the target printer is in the non-accepting state due to the target printer being offline as shown in FIG. 11, the notification information 328 is “Due to printer being offline, physical authentication cannot be accepted.” Although this is merely an example, in a case where the target printer is in the non-accepting state due to the target printer being in execution of the print function, the notification information 328 is “Because printer is executing print function, physical authentication cannot be accepted”. Further, although this is merely an example, in a case where the target printer is in the non-accepting state due to the user being operating the operation unit of the target printer, the notification information 328 is “Because printer is being operated by another user, physical authentication cannot be accepted.” Further, although this is merely an example, in a case where the target printer is in the non-accepting state due to communication being inexecutable between the target printer and the server 200, the notification information 328 is “Because printer cannot communicate with server, physical authentication cannot be accepted.” As such, by looking at the notification screen 326, a user of the terminal device 100 (hereafter, “target user”), can acknowledge that the target printer is in the non-accepting state and the cause why the target printer is in the non-accepting state. Accordingly, user convenience is improved.

In S64 of FIG. 4, the app 142 monitors for the Retry button 330 (see FIG. 7) on the notification screen 326 being operated. In a case where the app 142 accepts the operation on the Retry button 330, the app 142 determines YES to S64 and returns to S60. According to such configuration, by operating the Retry button 330, the target user can re-acknowledge whether the target printer is in the non-accepting state. Accordingly, user convenience is improved.

Also, in S66, the app 142 monitors for, simultaneously with the monitoring of S64, the Cancel button 332 (see FIG. 7) on the notification screen 326 being operated. In a case where the app 142 accepts operation on the Cancel button 332, the app 142 determines YES to S66 and returns to S52.

In S70, the app 142 sends a maintaining request to the target printer. The maintaining request is a signal for requesting the target printer to maintain the accepting state over a predetermined time period (e.g., two minutes). In a case where the target printer receives the maintaining request from the app 142, the target printer maintains the accepting state over the predetermined time period. Due to this, the target printer does not receive the print instruction sent from another device from when the maintaining request is received until the predetermined time period elapses. Further, the target printer does not accept any operation other than the physical authentication from when the maintaining request is received until the predetermined time period elapses. According to such operation, a possibility of the target printer being in the accepting state when the target user performs the physical authentication on the target printer can be increased. Accordingly, user convenience is improved. Alternatively in a modification, the target printer may maintain the accepting state from when the maintaining request is received until the physical authentication is accepted.

In S72, the app 142 determines whether the target user is logged in the server 200. In a case where the target user is logged in the server 200 (YES to S72), the app 142 proceeds to S78, and in a case where the target user is not logged in the server 200 (NO to S72), the app 142 proceeds to S74.

In S74, the app 142 causes the display unit 114 to display a log in screen 340. As shown in FIG. 7, the log in screen 340 includes a user ID inputting field 342 for inputting a user ID, a password inputting field 344 for inputting a password, and a Login button 346.

In S76 of FIG. 4, the app 142 accepts a login operation of inputting a user ID and a password. When the app 142 accepts the login operation, the app 142 sends the inputted user ID and password to the server 200. By the server 200 receiving the user ID and password and user authentication using the user ID and password succeeding, login of the target user into the server 200 is completed.

S78 is the same as S56. In a case where the app 142 determines YES to S78, the app 142 proceeds to S82 and in a case where the app 142 determines NO to S78, the app 142 proceeds to S80.

In S80, the app 142 causes the display unit 114 to display an instruction screen 350 for prompting the user to perform the physical authentication. As shown in FIG. 7, the instruction screen 350 includes a prompt message 352 for prompting the user to perform the physical authentication and a Next button 354. Although this is merely an example, the prompt message 352 is “Please press color copy button and monochrome copy button simultaneously”. Due to this, the target user can acknowledge a content of the physical authentication and that he/she needs to perform the physical authentication. Alternatively in a modification, the physical authentication may be operation on an object (e.g., OK button) on a screen displayed on a display unit of the target printer.

Although this is not shown, when the physical authentication is performed on the target printer, the target printer displays a confirmation screen for confirming whether a first subscription process may be started or not. Here, even if the physical authentication is performed on the target printer with the target printer being in the non-accepting state, the confirmation screen is not displayed because the target printer cannot accept the physical authentication. The first subscription process is for subscribing to the charge service. When an operation for starting the first subscription process is performed on the target printer, the first subscription process is executed between the target printer, the terminal device 100, and the server 200. The first subscription process includes establishing process, first registration process, and payment process, for example. The establishing process is for establishing fulltime connection between the target printer and the server 200. The fulltime connection is for example Extensible Messaging and Presence Protocol (XMPP) connection. The first registration process is for registering the device ID of the target printer (hereafter “target device ID”) in the first registration information in the user table 244 of the server 200. In response to the target device ID being sent from the target printer to the server 200, the target device ID is registered in the first registration information. The payment process is for paying a print fee. The first subscription process includes the server 200 sending a plurality of screen data (web pages) to the terminal device 100. The terminal device 100 uses a Web View function and thus causes the display unit 114 to display the screen data sent from the server 200. Here, in a case where fulltime connection is already established (present) between the target printer and the server 200 at the time of the first subscription process being executed, that is, in a case where the target user has already subscribed to a service different from the charge service, the establishing process is omitted.

In S82, the app 142 causes the display unit 114 to display a process in-execution screen 400. The process in-execution screen 400 includes a message 402 indicating that the first subscription process is in execution (e.g., “the first subscription process is in execution now.”). Here, in a case where NO is determined to S78, the app 142 causes the display unit 114 to display the process in-execution screen 400 in a case where the app 142 receives information indicating that the physical authentication has been accepted from the target printer after the instruction screen 350 (see FIG. 7) has been displayed on the display unit 114.

In S84, the app 142 monitors for the first subscription process being completed. For example, in a case where the app 142 receives a notification indicating that the first subscription process has completed from the server 200, the app 142 determines that the first subscription process has completed. In a case where the app 142 determines that the first subscription process has completed, the app 142 determines YES to S84 and ends the process of FIG. 4.

### (Second Screen Display Process; FIGS. 5 and 8)

With reference to FIGS. 5 and 8, the second screen display process executed in S20 and S32 in FIG. 3 will be described.

In S100, the app 142 determines whether the target printer supports the remote print service or not. Similar to S50 in FIG. 4, the app 142 sends the support information request including the target model name to the server 200, and receives the support information from the server 200. In a case where the remote print service information in the support information is “ON” (YES to S100), the app 142 proceeds to S102. Contrary to this, in a case where the remote print service information is “OFF” (NO to S100), the app 142 ends process of FIG. 5.

In S102, the app 142 causes the display unit 114 to display a remote print service screen 360. As shown in FIG. 8, the remote print service screen 360 includes a second service message 362, a Next button 364, and a Cancel button 366. The second service message 362 indicates a content of the remote print service. Although this is an example, the second service message 362 is “If you subscribe to remote print service, you can execute print using printer from outside.”

In S104 of FIG. 5, the app 142 monitors for the Next button 364 (see FIG. 8) on the remote print service screen 360 being operated. In a case where the app 142 accepts the operation on the Next button 364, the app 142 determines YES to S104 and proceeds to S106.

S106 and S110 are the same as S56, S60 in FIG. 4, respectively. In a case where YES is determined to S106, the app 142 proceeds to S122, and in a case where NO is determined to S106, the app 142 proceeds to S110. In a case where YES is determined to S110, the app 142 proceeds to S112, and NO is determined to S110, the app 142 proceeds to S120. S112 is the same as S62 in FIG. 4 except that the notification screen 326 is displayed on the remote print service screen 360 (see FIG. 8). S114, S116 are the same as S64, S66 in FIG. 4, respectively. In a case where YES is determined to S114, the app 142 returns to S110, and in a case where YES is determined to S116, the app 142 returns to S102. S120 to S130 are the same as S70 to S80 in FIG. 4. S132 is the same as S82 except that a process in-execution screen 410 including a message 412 indicating that the second subscription process is in execution (e.g., “Second subscription process is in execution now”) is displayed on the display unit 114.

When the physical authentication is performed on the target printer after the instruction screen 350 (see FIG. 8) has been displayed on the display unit 114, the target printer displays a confirmation screen for confirming whether the second subscription process may be started or not. The second subscription process is for subscribing to the remote print service. When an operation for starting the second subscription process is performed on the target printer, the second subscription process is executed between the target printer, the terminal device 100, and the server 200. The second subscription process includes the establishing process, and second registration process, for example. The second registration process is for registering a target device ID in the second registration information in the user table 244 of the server 200. In response to the target device ID being sent from the target printer to the server 200, the target device ID is registered in the second registration information. Here, in the second subscription process, as in the first subscription process, the establishing process may be omitted.

In S134, the app 142 monitors for the second subscription process being completed. For example, in a case where the app 142 receives a notification indicating that the second subscription process has completed from the server 200, the app 142 determines that the second subscription process has completed. In a case where the app 142 determines that the second subscription process has completed, the app 142 determines YES to S134 and ends process of FIG. 5.

### (Third Screen Display Process; FIGS. 6 and 9)

With reference to FIGS. 6 and 9, third screen display process executed in S22, S42 of FIG. 3 will be described.

In S150, the app 142 determines whether the target printer supports the subscription service or not. Similar to S50 in FIG. 4, the app 142 sends a support information request including the target model name to the server 200, and receives the support information from the server 200. In a case where the subscription service information in the received support information is “ON” (YES to S150), the app 142 proceeds to S152. Contrary to this, in a case where the subscription service information is “OFF” (NO to S150), the app 142 ends process of FIG. 6.

In S152, the app 142 causes the display unit 114 to display a subscription service screen 370. As shown in FIG. 9, the subscription service screen 370 includes a third service message 372, a Next button 374, and a Cancel button 376. The third service message 372 indicates a content of the subscription service. Although this is an example, the third service message 372 is “If you register to subscription service, you can print at flat-rate.”

In S154 of FIG. 6, the app 142 monitors for the Next button 364 (see FIG. 9) on the subscription service screen 370 being operated. In a case where the app 142 accepts the operation on the Next button 364, the app 142 determines YES to S154 and proceeds to S156.

S156, S160 are the same as S56, S60 in FIG. 4, respectively. In a case where the app 142 determines YES to S156, the app 142 proceeds to S172, and in a case where the app 142 determines NO to S156, the app 142 proceeds to S160. In a case where the app 142 determines YES to S160, the app 142 proceeds to S162 and in a case where the app 142 determines NO to S160, the app 142 proceeds to S170. S162 is the same as S62 in FIG. 5 except that the notification screen 326 is displayed on the subscription service screen 370 (see FIG. 9). S154, S156 are respectively the same as S64, S66 in FIG. 4, respectively. In a case where the app 142 determines YES to S164, the app 142 returns to S160, and in a case where the app 142 determines YES to S166, the app 142 returns to S152. S170 to S180 are the same as S70 to S80 in FIG. 4. S182 is the same as S82 except that a process in-execution screen 420 including a message 422 indicating that third subscription process is in execution (e.g., “Third subscription process is in execution”) is displayed on the display unit 114.

In a case where the physical authentication is performed on the target printer after the instruction screen 350 (see FIG. 9) has been displayed on the display unit 114, the target printer displays a confirmation screen for confirming whether the third subscription process may be started or not. The third subscription process is for subscribing to the subscription service. When an operation for starting the third subscription process is performed on the target printer, the third subscription process is executed between the target printer, the terminal device 100, and the server 200. The third subscription process includes the establishing process and third registration process, for example. The third registration process is for registering the target device ID in the third registration information in the user table 244 of the server 200. In response to the target device ID being sent from the target printer to the server 200, the target device ID is registered in the third registration information. Here, in the third subscription process, as in the first subscription process, the establishing process may be omitted.

In S184, the app 142 monitors for the third subscription process being completed. For example, in a case where the app 142 receives a notification indicating that the third subscription process has completed from the server 200, the app 142 determines that the third subscription process has completed. In a case where the app 142 determines that the third subscription process has completed, the app 142 determines YES to S184 and ends process of FIG. 6.

### (Specific Cases; FIGS. 7 to 11)

With reference to FIGS. 7 to 11, screens displayed on the display unit 114 of the terminal device 100 in specific cases A to D will be described.

### (Case A; FIG. 7)

With reference to FIG. 7, Case A in which a printer is unregistered (i.e., not registered) in the terminal device 100 and the target user has not subscripted to a service will be described. At an initial state of Case A, the printer 10A is offline. Also, the user table 244 of the server 200 is in a vacant state. Hereafter, operations executed by a CPU of each device (e.g., the CPU 132) will be described with each device (e.g., the terminal device 100) as a subject of action, without describing the CPU as a subject of action.

When the terminal device 100 accepts the app activating operation, the printer determines that the printer is unregistered in the terminal device 100, and displays the home screen 300 including the device object 306 with a character string “Not Selected” written therein (S10 in FIG. 3). When the terminal device 100 accepts a device selection operation for operating the device object 306 on the home screen 300 (YES to S12), the terminal device 100 executes search process and displays the device selection screen 310 (S14). In a case where the terminal device 100 accepts an operation on a device button 312 on the device selection screen 310 (YES to S16), the terminal device 100 executes the first screen display process (S18 in FIG. 3, and FIG. 4). The terminal device 100 sends the support information request including the model name “MN1” of the printer 10A to the server 200, and receives the support information including the charge service information “ON”, the remote print service information “ON”, and the subscription service information “OFF”. The terminal device 100 determines that the charge service information in the received support information is “ON” (YES to S50 in FIG. 4), the terminal device 100 displays the charge service screen 320 (S52).

When the terminal device 100 accepts an operation on the Next button 324 on the charge service screen 320 (YES to S54), the terminal device 100 sends an inquiry signal including the model name “MN1” to the server 200 and receives unregistered information from the server 200. In this case, the terminal device 100 determines that the printer 10A is not registered in the server 200 (YES to S60), and sends the status information request to the printer 10A. In the present case, because the printer 10A is offline, the terminal device 100 does not receive status information from the printer 10A even if a predetermined time period elapses from when the status information request was sent to the printer 10A, which makes timeout. In this case, the terminal device 100 determines that the printer 10A is in the non-accepting state (YES to S60), and displays the notification screen 326 including the notification information 328 on the charge service screen 320. The notification information 328 in the present case indicates that the printer 10A is offline.

After the notification screen 326 has been displayed, the targe user performs an operation for shifting the printer 10A from the offline state to online state on the printer 10A. Due to this, the printer 10A changes from the non-accepting state to the accepting state. Next, the target user operates the Retry button 330 on the notification screen 326 (YES to S64). Due to this, the terminal device 100 re-sends the status information request to the printer 10A. Since the printer 10A has changed from the non-accepting state to the accepting state, the terminal device 100 receives the status information from the printer 10A. In the present case, the print-related information indicates that the target printer is not in execution of the print function, the operation-related information indicates that the user is not operating the operation unit of the target printer, and the communication-related information indicates that communication is executable between the target printer and the server 200. Due to this, the terminal device 100 determines that the printer 10A is in the accepting state (NO to S60), and sends the maintaining request to the printer 10A (S70). Next, the terminal device 100 determines that the target user is not logged in the server 200 (NO to S72), and displays the log in screen 340 (S72). When the terminal device 100 accepts input of the user ID “U1” and a password (YES to S76), the terminal device 100 sends the inputted user ID “U1” and password to the server 200. Subsequently, the terminal device 100 determines that the printer 10A is not registered in the server 200 (YES to S78). In this case, the printer 10A displays the instruction screen 350 (S80).

When the physical authentication and an operation for starting the first subscription process are performed on the printer 10A after the instruction screen 350 has been displayed on the terminal device 100, the first subscription process is executed between the printer 10A, the terminal device 100, and the server 200. In a case where the terminal device 100 receives information indicating that the physical authentication has been accepted from the printer 10A, the terminal device 100 displays the process in-execution screen 400 (see FIG. 4) (S82). In a case where the terminal device 100 receives a notification indicating that the first subscription process has completed from the server 200, the terminal device 100 determines that the first subscription process has completed (YES to S84) and ends the first screen display process (S18 in FIG. 3, FIG. 4). As such, in the user table 244 of the server 200, the user ID “U1” and the first registration information “DV1” are stored in association with each other. That is, the subscription of the target user to the charge service is completed.

Although not shown, thereafter, the terminal device 100 executes the second screen display process (S22 in FIG. 3, and FIG. 5) and the third screen display process (S24 in FIG. 3, and FIG. 6). In a case where the third screen display process ends, the terminal device 100 stores the device ID “DV1” and the model name “MN1” of the printer 10A in the memory 134, and displays the home screen 300. In the device object 306 of the home screen 300 displayed at this occasion, the device ID “DV1” and the model name “MN1” of the printer 10A are displayed.

### (Effects by Case A)

As mentioned above, in a case where the terminal device 100 accepts the device selection operation and also the printer 10A is in the non-accepting state, the terminal device 100 displays the notification information 328 before displaying the instruction screen 350. A possibility that the physical authentication is performed on the printer 10A after the device selection operation has been performed is high. According to the above configuration, the notification information 328 can be displayed at a suitable time. Accordingly, user convenience is improved.

The terminal device 100 displays the log in screen 340 before displaying the instruction screen 350 in the case where the printer 10A changes from the non-accepting state to the accepting state. The target user moves to a spot where the printer 10A is located in order to perform the physical authentication on the printer 10A. At this occasion, the target user may not bring the terminal device 100 to that spot. Due to this, if the log in screen 340 is displayed after the instruction screen 350 has been displayed, the target user may not notice that the log in screen 340 is displayed on the terminal device 100 after the target user has performed the physical authentication on the target printer. According to the above configuration, the targe user can be surely made to input the user ID “U1”.

### (Case B; FIG. 8)

With reference to FIG. 8, Case B in which the printer 10B is registered in the terminal device 100 and the target user has not yet subscribed to the service will be described. At an initial state of Case B, the user table 244 of the server 200 is in a vacant state.

When the terminal device 100 accepts the app activating operation, the terminal device 100 determines that the printer 10B is registered in the terminal device 100 and displays the home screen 300 including the device object 306 with the device ID “DV2” and the model name “MN2” written therein (S10 in FIG. 3). When the terminal device 100 accepts an operation on the Remote button 308 on the home screen 300 (YES to S30), the terminal device 100 executes the second screen display process (S32, FIG. 5). The terminal device 100 sends the support information request including the model name “MN2” of the printer 10B to the server 200, and receives the support information including the charge service information “OFF”, the remote print service information “ON”, and the subscription service information “ON” from the server 200. The terminal device 100 determines that the remote print service information in the received support information is “ON” (YES to S100 in FIG. 5), and displays the remote print service screen 360 (S102).

When the terminal device 100 accepts an operation on the Next button 364 on the remote print service screen 360 (YES to S104), the terminal device 100 sends an inquiry signal including the model name “MN2” to the server 200 and receives unregistered information from the server 200. In this case, the terminal device 100 determines that the printer 10B is not registered in the server 200 (YES to S106). Next, the terminal device 100 sends the status information request to the printer 10B. In the present case, a situation in which the printer 10B is in execution of the print function upon when the printer 10B receives the status information from the terminal device 100 will be assumed. In this case, the print-related information in the status information sent from the printer 10B to the terminal device 100 indicates that the printer 10B is in execution of the print function. The terminal device 100 determines that the printer 10B is in the non-accepting state due to the print-related information indicating that the printer 10B is in execution of the print function (YES to S110). In this case, the terminal device 100 displays the notification screen 326 including the notification information 328 on the remote print service screen 360 (S112). The notification information 328 in the present case indicates that the printer 10B is in execution of the print function.

After the target user has acknowledged that the execution by the printer 10B of the print function has completed, that is, that the printer 10B has changed from the non-accepting state to the accepting state, the target user operates the Retry button 330 in the notification screen 326 (YES to S114). Due to this, the terminal device 100 re-sends the status information request to the printer 10B, and receives the status information from the printer 10B. In this case, the terminal device 100 determines that the printer 10B is in the accepting state (NO to S110) and sends the maintaining request to the printer 10B (S120). Next, the terminal device 100 determines that the target user is not logged in the server 200 (NO to S122) and displays the log in screen 340 (S124). When the terminal device 100 accepts input of the user ID “U1” and password (YES to S126), and sends the inputted user ID “U1” and password to the server 200. Next, the terminal device 100 determines that the printer 10B is not registered in the server 200 (YES to S128). In this case, the terminal device 100 displays the instruction screen 350 (S120).

Thereafter, when the physical authentication and an operation for starting the second subscription process are performed on the printer 10B, the second subscription process is executed between the printer 10B, the terminal device 100, and the server 200. In a case where the terminal device 100 receives information indicating that the physical authentication has been accepted from the printer 10B, the terminal device 100 displays the process in-execution screen 410 (see FIG. 5) (S132). In a case where the terminal device 100 receives a notification indicating that the second subscription process has completed from the server 200, the terminal device 100 determines that the second subscription process has completed (YES to S134), and ends the second screen display process (S32 in FIG. 3, FIG. 5). Due to this, in the user table 244 of the server 200, the user ID “U1” and the second registration information “DV2” are stored in association with each other. That is, the subscription of the target user to the remote print service is completed.

### (Case C; FIG. 9)

With reference to FIG. 9, Case C in which the printer 10B is registered in the terminal device 100 and the target user has not subscribed to the service will be described. At an initial state of Case C, the user table 244 of the server 200 is in a vacant state.

The home screen 300 in FIG. 9 is the same as the home screen 300 in Case B of FIG. 8. When the terminal device 100 accepts an operation on the Subscription button 309 on the home screen 300 (YES to S40 in FIG. 3), the terminal device 100 executes the third screen display process (S42, FIG. 6). Similar to Case B, the terminal device 100 receives the support information corresponding to the model name “MN2” from the server 200. The terminal device 100 determines that the subscription service information in the received support information is “ON” (YES to S150 in FIG. 6), the terminal device 100 displays the subscription service screen 370 (S152).

When the terminal device 100 accepts an operation on the Next button 374 on the subscription service screen 370 (YES to S154), the terminal device 100 sends an inquiry signal including the model name “MN2” to the server 200, and receives unregistered information from the server 200. In this case, the terminal device 100 determines that the printer 10B is not registered in the server 200 (YES to S106). The terminal device 100 sends the status information request to the printer 10B. In the present case, at a timing of the printer 10B receiving the status information from the terminal device 100, the printer 10B is in the accepting state. Due to this, the terminal device 100 determines based on the status information received from the printer 10B that the printer 10B is in the accepting state (NO to S160), and the terminal device 100 does not display the notification screen 326. The terminal device 100 sends the maintaining request to the printer 10B (S170), the terminal device 100 determines that the target user is not logged in the server 200 (NO to S172), and displays the log in screen 340 (S174). When the terminal device 100 accepts input of the user ID “U1” and password (YES to S176), and sends the inputted user ID “U1” and password to the server 200. Subsequently, the terminal device 100 determines that the printer 10B is not registered in the server 200 (YES to S178). In this case, the terminal device 100 displays the instruction screen 350 (S180). Process executed thereafter is the same as that of Case B in FIG. 8 except that the third subscription process is executed and that the process in-execution screen 420 (see FIG. 6) is displayed. Due to this, in the user table 244 of the server 200, the user ID “U1” and the third registration information “DV2” are stored in association with each other. That is, subscription of the target user to the subscription service is completed.

### (Effects by Case C)

As mentioned above, in the case where the printer 10B is in the accepting state, the terminal device 100 does not display the notification information 328 but displays the instruction screen 350. In the case where the printer 10B is in the accepting state, the notification information 328 is unnecessary information for the target user. Accordingly, the unnecessary information can be suppressed from being displayed on the terminal device 100, and thus user convenience can be improved.

### (Case D; FIG. 10)

With reference to FIG. 10, Case D in which the printer 10A is registered in the terminal device 100 and the target user has subscribed to the charge service will be described. At an initial state of Case D, in the user table 244 of the server 200, the user ID “U1” and the first registration information “DV1” are stored in association with each other.

When the terminal device 100 accepts the app activating operation, the terminal device 100 determines that the printer 10A is registered in the terminal device 100, and displays the home screen 300 including the device object 306 with the device ID “DV1” and the model name “MN1” written therein (S10 in FIG. 3). When the terminal device 100 accepts an operation on the Remote button 308 on the home screen 300 (YES to S30), the terminal device 100 executes the second screen display process (S32, FIG. 5). Similar to Case A in FIG. 7, the terminal device 100 receives the support information corresponding to the model name “MN1” from the server 200. The terminal device 100 determines that the remote print service information in the received support information is “ON” (YES to S100 in FIG. 5), the terminal device 100 displays the remote print service screen 360 (S102).

When the terminal device 100 accepts an operation on the Next button 364 on the remote print service screen 360 (YES to S104), the terminal device 100 sends an inquiry signal including the model name “MN1” to the server 200, and receives registered information from the server 200. In this case, the terminal device 100 determines that the printer 10A is registered in the server 200 (YES to S106), and does not determine whether the printer 10A is in the non-accepting state or not. Next, the terminal device 100 determines that the target user is not logged in the server 200 (NO to S122), and displays the log in screen 340 (S124). When the terminal device 100 accepts an input of the user ID “U1” and password (YES to S126), the terminal device 100 sends the inputted user ID “U1” and password to the server 200, and determines that the printer 10A is registered in the server 200 (YES to S128). Thereafter, even if the physical authentication is not performed by the target user on the printer 10A, the second subscription process is executed between the printer 10A, the terminal device 100, and the server 200. Due to this, the terminal device 100 does not display the instruction screen 350 but displays the process in-execution screen 410 (see FIG. 5) (S132). In a case where the terminal device 100 receives a notification indicating that the second subscription process has completed from the server 200, the terminal device 100 determines that the second subscription process has completed (YES to S134), and ends the second screen display process (S32, FIG. 5). Due to this, in the user table 244 of the server 200, the user ID “U1” and the second registration information “DV1” are stored in association with each other. That is, with the target user having subscripted to the charge service, subscription of the target user to the remote print service is completed.

### (Effects by Case D)

As mentioned above, in a case where the printer 10A is in the non-accepting state and the device ID “DV1” is stored in the user table 244 of the server 200, the terminal device 100 does not display the notification information 328 or the instruction screen 350. In a case where the device ID “DV1” is stored in the user table 244 of the server 200, even if the physical authentication is not performed on the printer 10A, the second subscription process is executable. This is because the physical authentication has already been performed. Due to this, the notification information 328 and information displayed on the instruction screen 350 are unnecessary information for the target user. Accordingly, the unnecessary information can be suppressed from being displayed on the terminal device 100, and thus user convenience can be improved.

### Effects by Present Embodiment

According to the above configuration, in a case where the terminal device 100 determines that the target printer is in the non-accepting state by using the status information received from the target printer (YES to S60 in FIG. 4, YES to S110 in FIG. 5, YES to S160 in FIG. 6), the terminal device 100 causes the display unit 114 to display the notification information 328 before causing the display unit 114 of the terminal device 100 to display the instruction screen 350. Due to this, the user can acknowledge that the target printer is in the non-accepting state before performing the physical authentication on the target printer. Accordingly, user convenience is improved.

### CORRESPONDENCES

The controller 130 of the terminal device 100 is an example for “controller”. The printers 10A, 10B are examples of “function executing device”. The Retry button 330 in the notification screen 326 in FIG. 7 is an example for “retry object”. The print function is an example for “specific function”. The device selection operation, the remote print service selection operation, and the subscription service selection operation are examples for “specific operation”. The device ID is an example for “device identification information.” The user ID is an example for “user identification information”. The user ID and password are examples for “login information”.

S62 in FIG. 4, S112 in FIG. 5, and S162 in FIG. 6 are examples of processes executed by “display notification information regarding to the non-accepting state on a display of a terminal device”.

### Second Embodiment

A second embodiment will be described. The second embodiment differs from the first embodiment in a content of process executed in S60 in FIG. 4, S110 in FIG. 5, and S160 in FIG. 6. Configurations and processes that are common between the embodiments will be given the same reference numerals, and descriptions thereof may be omitted.

In S60 in FIG. 4, the app 142 sends a determination request to the target printer. The determination request is a signal for requesting the target printer to determine whether the target printer is in the non-accepting state or the accepting state. In a case where the target printer receives the determination request from the terminal device 100, the target printer determines whether the target printer is in the non-accepting state or the accepting state. Specifically, the target printer determines whether the target printer is in execution of the print function or not, whether the user is operating the operation unit of the target printer or not, and whether communication is inexecutable between the target printer and the server 200. In a case where the target printer is in execution of the print function, in a case where the user is operating the operation unit of the target printer, or in a case where communication is inexecutable between the target printer and the server 200, the target printer determines that the target printer is in the non-accepting state, and sends first result information indicating that the target printer is in the non-accepting state to the terminal device 100. Further, in a case where the target printer is not in execution of the print function, also the user is not operating the operation unit of the target printer, and also communication is executable between the target printer and the server 200, the target printer determines that the target printer is in the accepting state, and sends second result information indicating that the target printer is in the accepting state to the terminal device 100. In a case where the app 142 receives the first result information from the target printer, the app 142 determines YES to S60 and proceeds to S62, and in a case where the app 142 receives the second result information from the target printer, the app 142 determines NO to S60 and proceeds to S70. Here, in a case where the app 142 does not receive any result information from the target printer also, the app 142 determines YES to S60, and proceeds to S62. In S110 in FIGS. 5 and S160 in FIG. 6 also, the app 142 sends the determination request to the target printer, and determines whether the target printer is in the non-accepting state by using the result information received from the target printer. Here, process of determining whether the target printer is in the non-accepting state or the accepting state may be performed by using Application Programming Interface (API) stored in the target printer.

### Effects by Present Embodiment

According to the above configuration, in a case where the result information received from the target printer indicates that the target printer is in the non-accepting state (YES to S60 in FIG. 4, YES to S110 in FIG. 5, YES to S160 in FIG. 6), the terminal device 100 causes the display unit 114 to display the notification information 328 before causing the display unit 114 of the terminal device 100 to display the instruction screen 350. Due to this, the user can acknowledge that the target printer is in the non-accepting state before performing the physical authentication on the target printer. Accordingly, user convenience is improved. Further, process load on the terminal device 100 can be reduced as compared to a configuration in which the terminal device 100 determines whether the target printer is in the non-accepting state or the accepting state.

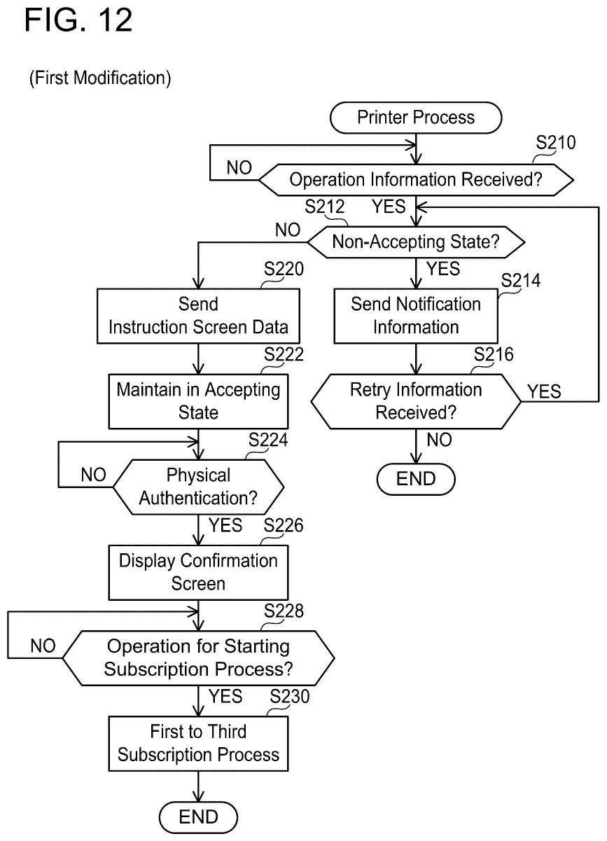

(First Modification) In the above first and second embodiments, the terminal device 100 displays the notification information 328 and the instruction screen 350 without receiving the notification information 328 or the instruction screen data indicating the instruction screen 350 from the target printer. In the present modification, the terminal device 100 receives the notification information 328 and the instruction screen data indicating the instruction screen 350 from the target printer. The printer 10A in the present modification executes printer process in FIG. 12.

### (Printer Process; FIG. 12)

With reference to FIG. 12, printer process executed by the CPU 32 of the printer 10A will be described.

In S210, the CPU 32 monitors for receiving the operation information from the terminal device 100. The operation information indicates that any of the device selection operation, the remote print service selection operation, and the subscription service selection operation has been performed. In a case where the CPU 32 receives the operation information from the terminal device 100, the CPU 32 determines YES to S210 and proceeds to S212.

In S212, the CPU 32 determines whether the printer 10A is in the non-accepting state or not. In a case where the printer 10A is in the non-accepting state (YES to S212), the CPU 32 proceeds to S214 and in a case where the printer 10A is in the accepting state (NO to S212), the CPU 32 proceeds to S220.

In S214, the CPU 32 sends notification screen data including the notification information 328 to the terminal device 100. In a case where the terminal device 100 receives the notification screen data from the printer 10A, the terminal device 100 displays the notification screen 326 (see FIG. 7).

In S216, the CPU 32 determines whether retry information has been received from the terminal device 100 or not. The retry information indicates that the Retry button 330 in the notification screen 326 has been operated. In a case where the CPU 32 receives the retry information from the terminal device 100 (YES to S216), the CPU 32 returns to S212 and in a case where the CPU 32 does not receive the retry information from the terminal device 100 (NO to S216), the CPU 32 ends the process of FIG. 12. Here, the case where the CPU 32 does not receive the retry information from the terminal device 100 is a case where the Cancel button 332 in the notification screen 326 is operated.

Further, in S220, the CPU 32 sends instruction screen data indicating the instruction screen 350 to the terminal device 100. In a case where the instruction screen data is received from the printer 10A, the terminal device 100 displays the instruction screen 350 (see FIG. 7).

In S222, the CPU 32 maintains the printer 10A in the accepting state over a predetermined time period (e.g., two minutes). That is, until the predetermined time period elapses from when the printer 10A was determined as in the accepting state, the printer 10A does not receive a print instruction sent from another device. Further, until the predetermined time period elapses from when the printer 10A was determined as in the accepting state, the printer 10A does not accept an operation other than the physical authentication. According to such configuration, a possibility where the target printer is in the accepting state when the target user performs the physical authentication on the target printer can be improved. Accordingly, user convenience is improved.

In S224, the CPU 32 monitors for accepting the physical authentication. In a case where the CPU 32 accepts the physical authentication, the CPU 32 determines YES to S224 and proceeds to S226.

In S226, the CPU 32 displays a confirmation screen for confirming whether to start subscription process for subscribing to a service or not.

In S228, the CPU 32 determines whether an operation for starting the subscription process has been performed or not. In a case where the CPU 32 accepts the operation for starting the subscription process (YES to S228), the CPU 32 proceeds to S230. Contrary to this, in a case where the CPU 32 does not accept the operation for starting the subscription process (NO to S228), the CPU 32 ends process of FIG. 12.

In S230, the CPU 32 executes the first subscription process, the second subscription process, or the third subscription process between the server 200 and the terminal device 100. When S230 ends, the CPU 32 ends the process of FIG. 12.

According to the above configuration, in the case where the printer 10A is in the non-accepting state (YES to S60 in FIG. 4, YES to S110 in FIG. 5, YES to S160 in FIG. 6), the printer 10A causes the display unit 114 of the terminal device 100 to display the notification information 328 before causing the display unit 114 to display the instruction screen 350. Due to this, the user can acknowledge that the printer 10A is in the non-accepting state before performing the physical authentication on the printer 10A. Accordingly, user convenience is improved.

In the present modification, the controller 30 of the printer 10A is an example for “controller”. S214 in FIG. 12 is an example for process executed by “display notification information regarding to the non-accepting state on a display of a terminal device”.

(Second Modification) The notification information 328 may include information for changing the state of the target printer from the non-accepting state to the accepting state. As shown in FIG. 11, although this is an example, in a case where the target printer is in the non-accepting state due to the target printer being offline, the notification information 328 is “Printer is offline. Please change printer to online state, then press retry button”. Further, although this is an example, in a case where the target printer is in the non-accepting state due to the target printer being in execution of print function, the notification information 328 is “Printer is executing print function. Please wait until printer has finished printing, then press retry button”. Further, although this is an example, in a case where the target printer is in the non-accepting state due to a user being operating the operation unit of the target printer, the notification information 328 is “Printer is being operated by another user. Please wait until the operation by another user has finished, then press retry button”. Further, although this is an example, in a case where the target printer is in the non-accepting state due to communication being inexecutable between the target printer and the server 200, the notification information 328 is “Printer cannot communicate with server. Please wait until it becomes possible for printer to communicate with server, then press retry button”. According to such configuration, the target user can acknowledge what to do to change the state of the target printer from the non-accepting state to the accepting state. Accordingly, user convenience is improved.

(Third Modification) The notification screen 326 may not include the Retry button 330. In the present modification, the app 142 may determine whether the target printer is in the non-accepting state or not in the case where a predetermined time period elapses after it was determined that the target printer was in the non-accepting state. That is, the app 142 re-determines whether the target printer is in the non-accepting state without accepting an operation from the user.

(Fourth Modification) The notification screen 326 may include a dropdown and/or slider switch for causing the terminal device 100 to re-determine whether the target printer is in the non-accepting state instead of the Retry button 330. In the present modification, the dropdown and/or slider switch are examples for “retry object”.

(Fifth Modification) The printer 10A, 10B may be in the non-accepting state in at least one of a state where the printer 10A, 10B is offline, a state where the printer 10A, 10B is in execution of the print function, a state where a user is operating the operation unit 12 of the printer 10A, 10B, and a state where communication is inexecutable between the printer 10A, 10B and the server 200.

(Sixth Modification) “Function executing device” may be configured to execute scan function, facsimile function, and/or copy function in addition to the print function. In the present modification, the function executing device may be in the non-accepting state in a case where the function executing device is in execution of the scan function, the function executing device in in execution of the facsimile function, or the function executing device is in execution of the copy function. In the present modification, the scan function, the facsimile function, and the copy function are examples for “specific function”.

(Seventh Modification) “Function executing device” may be configured to execute scan function and facsimile function in addition to the print function. In the present modification, physical authentication is necessary to change setting of a function of the function executing device. Although this is an example, the change of setting of a function of the function executing device is changing a state of the function executing device from an inactive state where the scan function is inactive to an active state where the scan function is active. In the present modification, the terminal device 100 displays the notification screen 326 before displaying the instruction screen 350 in a case where the terminal device 100 accepts an operation for changing the setting of a function of the function executing device and also where the function executing device is in the non-accepting state. In the present modification, the operation for changing the setting of a function of the function executing device is an example for “specific operation which is to be executed before the authentication operation”.

(Eighth Modification) The app 142 of the terminal device 100 may perform S72 to S76 after S80 in FIG. 4. Further, the app 142 may perform S132 to S136 after S130 in FIG. 5 and perform S172 to S176 after S180 in FIG. 6. That is, the app 142 may cause the display unit 114 to display the log in screen 340 after causing the display unit 114 to display the instruction screen 350.

(Ninth Modification) The terminal device 100 may display at least one of the notification screen 326 and the instruction screen 350 in a case where the printer 10A is in the non-accepting state and also the device ID “DV1” is stored in the user table 244 of the server 200. In the present modification, S56, S78 in FIG. 4, S106, S128 in FIG. 5, S156, S178 in FIG. 6 may be omitted.

(Tenth Modification) The terminal device 100 may not send the maintaining request to the target printer. In the present modification, S70 in FIG. 4, S120 in FIG. 5, and S170 in FIG. 6 may be omitted. In the present modification, “send a maintaining request to the function executing device” may be omitted.

(Eleventh Modification) In S60 in FIG. 4, the app 142 may send, to the target printer, a signal which requests for operation that simulates physical authentication to be performed. In a case where the target printer receives the signal from the terminal device 100, the target printer simulates the physical authentication. Then, in a case where a confirmation screen is displayed on the display unit of the target printer after the physical authentication has been simulated, the target printer determines that the physical authentication has succeeded and sends success information to the terminal device 100. Contrary to this, in a case where the confirmation screen is not displayed on the display unit of the target printer after the physical authentication has been simulated, the target printer determines that the physical authentication has failed, and sends failure information to the terminal device 100. In a case where the terminal device 100 receives the success information from the target printer, the terminal device 100 determines that the target printer is in the accepting state (NO to S60), and in a case where the terminal device 100 receives the failure information from the target printer, the terminal device 100 determines that the target printer is in the non-accepting state (YES to S60). Here, in a case where the app 142 receives the success information from the target printer, the app 142 sends a deletion request which requests for deletion of the confirmation screen to the target printer. A similar process may be executed in S110 in FIG. 5, and S160 in FIG. 6.

(Twelfth Modification) In each of the above embodiments, the process of FIGS. 3 to 12 is realized by software (e.g., programs 40, 140, 142, 240), but at least one of the process may be realized by hardware such as logic circuitry.

In the disclosure, “at least one of A, B and C” means “A”, “B”, “C”, “A and B”, “A and C”, “B and C”, or “A, B and C”.

What is claimed is:

1. A non-transitory computer-readable recording medium storing computer-readable instructions for a control device comprising a processor,
wherein the computer-readable instructions, when executed by the processor, cause the control device to:
in a case where a function executing device is in a non-accepting state in which the function executing device is not capable of accepting an authentication operation, display notification information regarding to the non-accepting state on a display of a terminal device before displaying an instruction screen for prompting a user to execute the authentication operation on the display.

2. The non-transitory computer-readable recording medium according to claim 1, wherein the notification information includes information indicating that the function executing device is in the non-accepting state.

3. The non-transitory computer-readable recording medium according to claim 1, wherein the notification information includes information for changing a state of the function executing device from the non-accepting state to an accepting state in which the function executing device is capable of accepting the authentication operation.

4. The non-transitory computer-readable recording medium according to claim 1, wherein the computer-readable instructions, when executed by the processor, further cause the control device to:
determine whether the function executing device is in the non-accepting state or an accepting state in which the function executing device is capable of accepting the authentication operation,
wherein in a case where it is determined that the function executing device is in the non-accepting state, the notification information and a retry object are displayed on the display before displaying the instruction screen on the display, and
in a case where an operation on the retry object is accepted, whether the function executing device is in the non-accepting state or the accepting state is re-determined.

5. The non-transitory computer-readable recording medium according to claim 1, wherein the computer-readable instructions, when executed by the processor, further cause the control device to:
in a case where the function executing device is in an accepting state in which the function executing device is capable of accepting the authentication operation, display the instruction screen on the display without displaying the notification information on the display.

6. The non-transitory computer-readable recording medium according to claim 1, wherein the computer-readable instructions, when executed by the processor, further cause the control device to:
display the instruction screen on the display in a case where a state of the function executing device is changed from the non-accepting state to an accepting state in which the function executing device is capable of accepting the authentication operation after the notification information has been displayed on the display.

7. The non-transitory computer-readable recording medium according to claim 1, wherein the non-accepting state includes a state in which the function executing device is offline.

8. The non-transitory computer-readable recording medium according to claim 1, wherein the non-accepting state includes a state in which the function executing device is executing a specific function.

9. The non-transitory computer-readable recording medium according to claim 1, wherein the non-accepting state includes a state in which a user is operating an operation unit of the function executing device.

10. The non-transitory computer-readable recording medium according to claim 1, wherein the non-accepting state includes a state in which communication between the function executing device and a server is inexecutable.

11. The non-transitory computer-readable recording medium according to claim 1, wherein the control device is a controller of the terminal device, and
the computer-readable instructions, when executed by the processor, further cause the control device to:
accept a specific operation which is to be executed before the authentication operation,
wherein in a case where the specific operation is accepted and the function executing device is in the non-accepting state, the notification information is displayed on the display before displaying the instruction screen on the display.

12. The non-transitory computer-readable recording medium according to claim 11, wherein the specific operation is for selecting the function executing device,
wherein the function executing device is configured to, in a case where the authentication operation is accepted after the instruction screen has been displayed on the display, send device identification information identifying the function executing device to a server that provides a service related to the function executing device, and
the server is configured to store the device identification information in a case where the device identification information is received from the function executing device.

13. The non-transitory computer-readable recording medium according to claim 12, wherein the computer-readable instructions, when executed by the processor, further cause the control device to:
display a login screen for logging in to the server on the display before displaying the instruction screen on the display in a case where a state of the function executing device changes from the non-accepting state to an accepting state in which the function executing device is capable of accepting the authentication operation after the notification information has been displayed on the display; and
send the login information to the server in response to login information including user identification information being inputted to the login screen,
wherein in a case where the login information is received from the terminal device and the device identification information is received from the function executing device, the server is configured to store the user identification information included in the login information and the device identification information in association with each other.

14. The non-transitory computer-readable recording medium according to claim 12, wherein in a case where the function executing device is in the non-accepting state and the device identification information is not stored in the server, the notification information is displayed on the display before displaying the instruction screen on the display, and
in a case where the function executing device is in the non-accepting state and the device identification information is stored in the server, the notification information and the instruction screen are not displayed.

15. The non-transitory computer-readable recording medium according to claim 11, wherein the computer-readable instructions, when executed by the processor, further cause the control device to:
in a case where the specific operation is accepted and the function executing device is in an accepting state in which the function executing device is capable of accepting the authentication operation, send a maintaining request to the function executing device, the maintaining request requesting the function executing device to maintain the accepting state over a predetermined time period.

16. The non-transitory computer-readable recording medium according to claim 11, wherein the computer-readable instructions, when executed by the processor, further cause the control device to:
in a case where the specific operation is accepted, send operation information indicating that the specific operation has been accepted to the function executing device,
wherein the function executing device is configured to maintain the accepting state over a predetermined time period in a case where the operation information is received under an accepting state in which the function executing device is capable of accepting the authentication operation.

17. The non-transitory computer-readable recording medium according to claim 1, wherein the control device is a controller of the terminal device, and
the computer-readable instructions, when executed by the processor, further cause the control device to:
send, to the function executing device, a status information request requesting status information indicating a status of the function executing device to be sent;
in response to the status information request being sent to the function executing device, receive the status information from the function executing device; and
in a case where the status information is received from the function executing device, determine, by using the status information, whether the function executing device is in the non-accepting state or an accepting state in which the function executing device is capable of accepting the authentication operation,
wherein in a case where it is determined that the function executing device is in the non-accepting state, the notification information is displayed on the display before displaying the instruction screen on the display.

18. The non-transitory computer-readable recording medium according to claim 1, wherein the control device is a controller of the terminal device, and
the computer-readable instructions, when executed by the processor, further cause the control device to:
send, to the function executing device, a determination request requesting the function executing device to determine whether the function executing device is in the non-accepting state or an accepting state in which the function executing device is capable of accepting the authentication operation; and
in response to the determination request being sent to the function executing device, receive result information indicating a determination result from the function executing device,
wherein in a case where the result information indicates that the function executing device is in the non-accepting state, the notification information is displayed on the display before displaying the instruction screen on the display.

19. A control device comprising:
a display; and
a controller configured to:
in a case where a function executing device is in a non-accepting state in which the function executing device is not capable of accepting an authentication operation, display notification information regarding the non-accepting state on a display of terminal device before displaying an instruction screen for prompting a user to execute the authentication operation on the display.

20. A method for controlling a control device, the method comprising:
in a case where a function executing device is in a non-accepting state in which the function executing device is not capable of accepting an authentication operation, displaying notification information regarding the non-accepting state on a display of a terminal device before displaying an instruction screen for prompting a user to execute the authentication operation on the display.
